(19) United States
(12) Patent Application Publication
(10) Pub. No.: US 2024/0340813 A1
(43) Pub. Date: Oct. 10, 2024

(54) SIDELINK TRANSMISSION POWER CONTROL FOR NEW RADIO SIDELINK AND LONG TERM EVOLUTION SIDELINK CO-CHANNEL COEXISTENCE

(71) Applicant: QUALCOMM Incorporated, San Diego, CA (US)

(72) Inventors: Sourjya DUTTA, San Diego, CA (US); Gabi SARKIS, San Diego, CA (US); Tien Viet NGUYEN, Bridgewater, NJ (US)

(21) Appl. No.: 18/596,088

(22) Filed: Mar. 5, 2024

Related U.S. Application Data
(60) Provisional application No. 63/494,745, filed on Apr. 6, 2023.

(51) Int. Cl. H04W 52/38; H04W 52/36

(52) U.S. Cl. CPC H04W 52/383; H04W 52/367

(57) ABSTRACT

Various aspects of the present disclosure generally relate to wireless communication. In some aspects, a user equipment (UE) may determine to transmit data associated with a first radio access technology (RAT) on a set of consecutive slots, associated with the first RAT, that map to a time period associated with a second RAT. The UE may determine a set of transmit powers associated with the set of consecutive slots. The UE may transmit the data associated with the first RAT using the set of transmit powers and in accordance with a first numerology. The first numerology may be associated with the first RAT and may be different than a second numerology that is associated with the second RAT. Numerous other aspects are described.

### CROSS-REFERENCE TO RELATED APPLICATION

This patent application claims priority to U.S. Provisional Patent Application No. 63/494,745, filed on Apr. 6, 2023, entitled “SIDELINK TRANSMISSION POWER CONTROL FOR NEW RADIO SIDELINK AND LONG TERM EVOLUTION SIDELINK CO-CHANNEL COEXISTENCE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for sidelink transmission power control for New Radio sidelink and Long Term Evolution sidelink co-channel coexistence.

### BACKGROUND

Wireless communication systems are widely deployed to provide various telecommunication services such as telephony, video, data, messaging, and broadcasts. Typical wireless communication systems may employ multiple-access radio access technologies (RATs) capable of supporting communication with multiple users by sharing available system resources (for example, bandwidth or transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access technologies have been adopted in various telecommunication standards to provide a common protocol that enables different wireless communication devices to communicate on a municipal, national, regional, or global level. An example telecommunication standard is New Radio (NR). NR, which may also be referred to as 5G, is part of a continuous mobile broadband evolution promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in NR may be implemented, and other radio access technologies such as 6G may be introduced to further advance mobile broadband evolution.

### SUMMARY

Some aspects described herein relate to a user equipment (UE) for wireless communication. The user equipment may include one or more memories and one or more processors coupled to the one or more memories. The one or more processors may be configured to cause the UE to determine to transmit data associated with a first radio access technology (RAT) on a set of consecutive slots, associated with the first RAT, that map to a time period associated with a second RAT. The one or more processors may be configured to cause the UE to determine a set of transmit powers associated with the set of consecutive slots. The one or more processors may be configured to cause the UE to transmit the data associated with the first RAT using the set of transmit powers and in accordance with a first numerology, wherein the first numerology is associated with the first RAT and is different than a second numerology that is associated with the second RAT.

Some aspects described herein relate to a method of wireless communication performed by a UE. The method may include determining to transmit data associated with a first RAT on a set of consecutive slots, associated with the first RAT, that map to a time period associated with a second RAT. The method may include determining a set of transmit powers associated with the set of consecutive slots. The method may include transmitting the data associated with the first RAT using the set of transmit powers and in accordance with a first numerology, wherein the first numerology is associated with the first RAT and is different than a second numerology that is associated with the second RAT.

Some aspects described herein relate to a non-transitory computer-readable medium that stores a set of instructions for wireless communication by a UE. The set of instructions, when executed by one or more processors of the UE, may cause the UE to determine to transmit data associated with a first RAT on a set of consecutive slots, associated with the first RAT, that map to a time period associated with a second RAT. The set of instructions, when executed by one or more processors of the UE, may cause the UE to determine a set of transmit powers associated with the set of consecutive slots. The set of instructions, when executed by one or more processors of the UE, may cause the UE to transmit the data associated with the first RAT using the set of transmit powers and in accordance with a first numerology, wherein the first numerology is associated with the first RAT and is different than a second numerology that is associated with the second RAT.

Some aspects described herein relate to an apparatus for wireless communication. The apparatus may include means for determining to transmit data associated with a first RAT on a set of consecutive slots, associated with the first RAT, that map to a time period associated with a second RAT. The apparatus may include means for determining a set of transmit powers associated with the set of consecutive slots. The apparatus may include means for transmitting the data associated with the first RAT using the set of transmit powers and in accordance with a first numerology, wherein the first numerology is associated with the first RAT and is different than a second numerology that is associated with the second RAT.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of sidelink communications in accordance with the present disclosure.

FIG. 5 is a diagram illustrating an example associated with sidelink transmission power control for new radio (NR) and long-term evolution (LTE) co-channel coexistence, in accordance with the present disclosure.

FIG. 6 is a diagram illustrating an example process performed, for example, by a UE, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to transmitting data over sidelink, in a first radio access technology (RAT) on a set of consecutive slots corresponding to a time period associated with a second RAT. Some aspects more specifically relate to determining a first transmit power for a first slot associated with a first RAT and a second transmit power for a second slot associated with the first RAT such that the first and second transmit powers are equal or within a specified range of one another.

Particular aspects of the subject matter described in this disclosure can be implemented to realize one or more of the following potential advantages. In some examples, the described techniques can be used to enable a network node to transmit over a sidelink associated with a first RAT on a co-channel with a second RAT, while facilitating correct automatic gain control (AGC) setting by a UE communicating on the second RAT across the overlapping time period. In this way, the described techniques may be used to improve sidelink network performance.

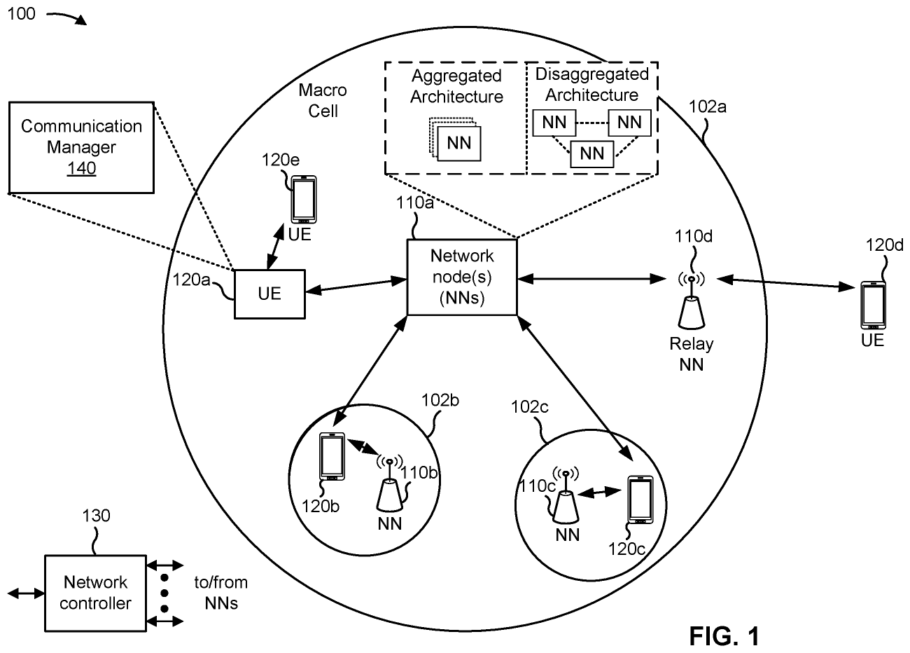

FIG. 1 is a diagram illustrating an example of a wireless network 100 in accordance with the present disclosure. The wireless network 100 may be or may include elements of a 5G (for example, NR) network or a 6G network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), and/or other network entities.

A network node 110 may include one or more devices that enable communication between a UE 120 and the wireless network 100. A network node 110 may include, for example, an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or a radio access network (RAN) node. As shown, a network node 110 may include one or more network nodes. In some aspects, a network node 110 may be an aggregated network node, meaning that the network node 110 may utilize a radio protocol stack that is physically and/or logically integrated within a single RAN node. For example, a network node 110 (an aggregated network node) may include a single standalone base station or a single TRP that may utilize a radio protocol stack (such as a full gNB protocol stack) to facilitate communication between a UE 120 and a core network associated with the wireless network 100.

In some aspects, a network node 110 may be a disaggregated network node (sometimes referred to as a disaggregated base station), meaning that the network node 110 may utilize a protocol stack that is physically distributed and/or logically distributed among two or more nodes in the same geographic location or in different geographic locations. For example, a network node 110 may include one of, or a combination of, one or more central units (CUs), one or more distributed units (DUs), one or more radio units (RUs), one or more integrated access and backhaul (IAB) nodes, one or more Near-Real Time (Near-RT) RAN Intelligent Controllers (RICs), and/or a Non-Real Time (Non-RT) RICs in the wireless network 100. For example, “a/the network node 110” may refer to a node that implements part of a protocol stack, a node that implements a full protocol stack, or a collection of nodes that collectively implement the protocol stack. In some cases, a CU, a DU, and/or an RU may be implemented as a virtual unit, such as a virtual central unit (VCU), a virtual distributed unit (VDU), or a virtual radio unit (VRU), among other examples.

Disaggregated network nodes 110 in the wireless network 100 may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. In some examples, a network node 110 may be or include a network node that communicates with other network nodes 110 via a fronthaul link or a midhaul link, such as a DU. For example, a DU may facilitate communication between an RU and a CU. In some examples, a network node 110 may be or include a network node that communicates with other network nodes 110 via a midhaul link or a core network via a backhaul link, such as a CU.

A network node 110 that relays communications may be referred to as a relay station, a relay network node, or a relay. A relay station may receive a transmission of data from an upstream station (for example, a network node 110 or a UE 120) and send a transmission of the data to a downstream station (for example, a UE 120 or a network node 110). In the example shown in FIG. 1, the network node 110d (for example, a relay network node) may communicate with the network node 110a (for example, a macro network node) and the UE 120d in order to facilitate communication between the network node 110a and the UE 120d. Additionally and/or alternatively, a UE 120 may be or may operate as a relay station that can relay transmissions for other UEs 120. A UE 120 that relays communications may be referred to as a UE relay or a relay UE, among other examples.

In some examples, a network node 110 may be or include a network node, such as an RU, a TRP, or a base station, that communicates with UEs 120 via a radio access link (which may be referred to as a “Uu” link). The radio access link may include a downlink and an uplink. “Downlink” (or “DL”) refers to a communication link from a network node 110 to a UE 120, and “uplink” (or “UL”) refers to a communication link from a UE 120 to a network node 110. The downlink may include one or more control channels on which control information (for example, scheduling information, reference signals, configuration information) may be transmitted and received, and one or more data channels on which data (for example, data associated with a UE 120) may be transmitted and received. The one or more control channels may include one or more physical downlink control channels (PDCCHs), and the one or more data channels may include one or more physical downlink shared channels (PDSCHs). The uplink may include one or more control channels on which control information (for example, feedback for one or more downlink transmissions, reference signals) may be transmitted and received, and one or more data channels on which data (for example, data associated with a UE 120) may be transmitted and received. The one or more control channels may include one or more physical uplink control channels (PUCCHs), and the one or more data channels may include one or more physical uplink shared channels (PUSCHs). The downlink and the uplink may each include a set of resources on which the network node 110 and the UE 120 may communicate.

The resources for the downlink and for the uplink may each include one or more time domain resources (frames, subframes, slots, symbols), frequency domain resources (frequency bands, frequency carriers, subcarriers, resource blocks, resource elements), spatial domain resources (particular transmit directions or beam parameters), or a combination thereof. The frequency domain resources for the downlink and/or for the uplink may be divided into one or more bandwidth parts (BWPs). A bandwidth part may refer to a continuous block of frequency domain resources that are allocated for one or more UEs 120. A bandwidth part may be dynamically configured (e.g., by a network node 110 transmitting a dynamic control information (DCI) configuration to the one or more UEs 120) and/or reconfigured, which means that a bandwidth part can be adjusted in real-time (or near-real-time) based on changing network conditions in the wireless network 100 and/or based on the specific requirements of the one or more UEs 120. This allows for more efficient use of the available frequency domain resources in the wireless network 100.

Some network nodes 110 (for example, a base station, an RU, a TRP) may provide communication coverage for a particular geographic area. In the Third Generation Partnership Project (3GPP), the term “cell” can refer to a coverage area of a network node 110 or a network node subsystem serving this coverage area, depending on the context in which the term is used. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, relay network nodes, aggregated network nodes, and/or disaggregated network nodes, among other examples. Some types of network nodes 110 may have different transmit power levels, different coverage areas, and/or different impacts on interference in the wireless network 100 than other types of network nodes. For example, macro network nodes may have a high transmit power level (for example, 5 to 40 watts), whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node such as a train, a satellite base station, a drone, or a non-terrestrial network (NTN) network node).

A network controller 130 may couple to or communicate with a set of network nodes 110 and may provide coordination and control for these network nodes 110. In some aspects, the wireless network 100 includes one or more network controllers 130. Additionally and/or alternatively, a core network associated with the wireless network 100 may include one or more network controllers 130. A network controller 130 may communicate with a network node 110 via a backhaul communication link. The backhaul link may facilitate communication between the wireless network 100 and the core network. In some aspects, the network controller 130 may be, include, or be included in a CU or a core network device.

The UEs 120 may be dispersed throughout the wireless network 100, and each UE 120 may be stationary or mobile. A UE 120 may be, include, or be included in, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter or sensor, industrial manufacturing equipment, a Global Positioning System device (or other position device), a UE function of a network node, or any other suitable device or function that may communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment.

A UE 120 may include, or may be included in, a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some aspects, two or more UEs 120 (for example, shown as UE 120a and UE 120e) may communicate directly using one or more sidelink channels (for example, without communicating through a network node 110 as an intermediary to communicate with one another). As an example, the UE 120a may transmit a sidelink communication to the UE 120e directly on a sidelink instead of transmitting the sidelink communication to a network node 110 on an uplink for the network node 110 to then transmit the sidelink communication to the UE 120e on a downlink. The UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, a vehicle-to-pedestrian (V2P) protocol), and/or a mesh network. In some examples, a network node 110 may still schedule and/or allocate resources for sidelink communication between UEs 120 in the wireless network 100. Alternatively, a UE 120 may perform scheduling operations, resource selection operations, and/or other operations described elsewhere herein for sidelink communication instead of a network node 110.

Devices (for example, UEs 120, network nodes 110) of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular RAT and may operate on one or multiple carrier frequencies in one or multiple frequency ranges such as 410 MHz-7.125 GHz or 24.25 GHz-52.6 GHz, among other examples. A RAT may also be referred to as an air interface and may include a 4G RAT, a 5G/NR RAT, and/or a 6G RAT, among other examples. In some examples, when multiple RATs are deployed in a given geographic area, each RAT in the geographic area may operate on different frequencies in order to avoid interference between wireless networks of different RATs.

In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may be referred to as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands may extend 5G NR operation, 6G operation, and/or other RATs beyond 52.6 GHz. For example, three higher operating bands may be referred to as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., the UE 120) may include a communication manager 140. As described in more detail elsewhere herein, the communication manager 140 may determine to transmit data associated with a first RAT on a set of consecutive slots, associated with the first RAT, that map to a time period associated with a second RAT; determine a set of transmit powers corresponding to the set of consecutive slots; and transmit the data associated with the first RAT using the set of transmit powers and in accordance with a first numerology, wherein the first numerology is associated with the first RAT and is different than a second numerology that is associated with the second RAT. Additionally, or alternatively, the communication manager 140 may perform one or more other operations described herein.

As indicated above, FIG. 1 is provided as an example. Other examples may differ from what is described with regard to FIG. 1.

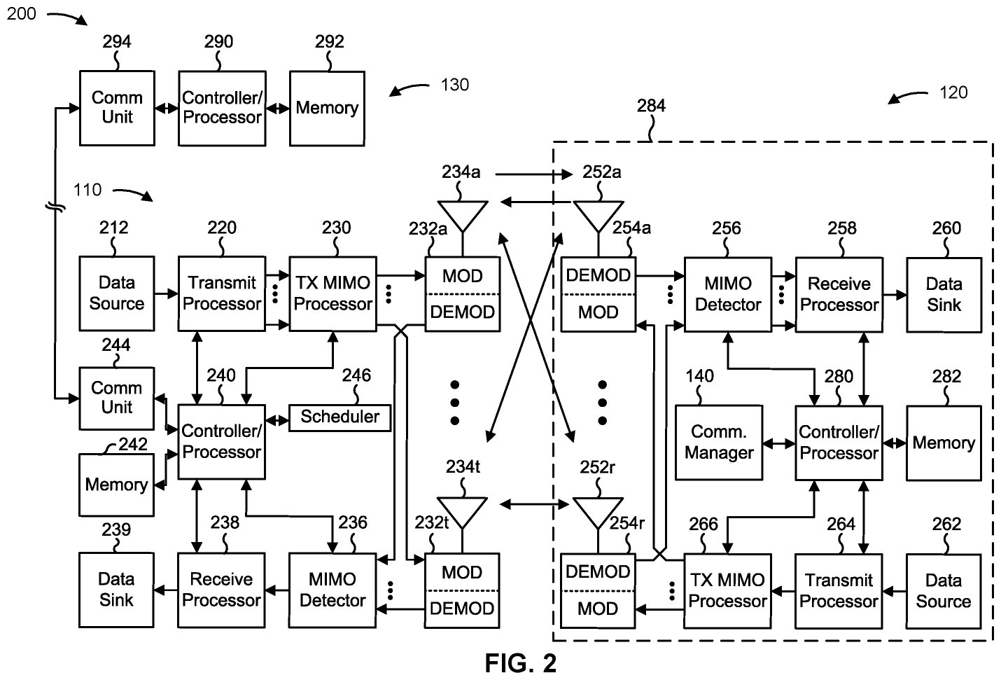

FIG. 2 is a diagram illustrating an example 200 of a network node in communication with a UE in a wireless network in accordance with the present disclosure. The network node may correspond to the network node 110 of FIG. 1. Similarly, the UE may correspond to the UE 120 of FIG. 1.

As shown in FIG. 2, the network node 110 may include a data source 212, a transmit processor 220, a transmit (TX) multiple-input multiple-output (MIMO) processor 230, a set of modems 232 (such as 232a through 232t, where t≥1), a set of antennas 234 (such as 234a through 234t, where t≥1), a MIMO detector 236, a receive processor 238, a data sink 239, a controller/processor 240, a memory 242, a communication unit 244, and/or a scheduler 246, among other examples. In some aspects, one or a combination of the antenna(s) 234, the modem(s) 232, the MIMO detector 236, the receive processor 238, the transmit processor 220, or the TX MIMO processor 230 may be included in a transceiver that is included in the network node 110. The transceiver may be used by a processor (for example, the controller/processor 240) and the memory 242 to perform aspects of any of the methods described herein. In some aspects, a network node 110 may include another interface, another communication component, and/or another component (such as a network interface) that facilitates communication with the UE 120 or another network node. Some network nodes 110 (such as one or more CUs or one or more DUs) may not include radio frequency components that facilitate direct communication with the UE 120.

For communication on a downlink, the transmit processor 220 may receive data, from the data source 212. The data may be intended for the UE 120 (or a set of UEs 120), and may thus be referred to as downlink data. In some implementations, the transmit processor 220 may select one or more modulation and coding schemes (MCSs) for the UE 120 in accordance with one or more channel quality indicators (CQIs) received from the UE 120. The network node 110 may process the data (for example, may encode the data) for transmission to the UE 120 on a downlink in accordance with the MCS(s) selected for the UE 120 to generate data symbols, and may provide the data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS), a demodulation reference signal (DMRS), or a channel state information (CSI) reference signal) and synchronization signals (for example, a primary synchronization signal (PSS) or a secondary synchronization signals (SSS)).

The TX MIMO processor 230 may perform spatial processing (for example, precoding) on the data symbols, the control symbols, the overhead symbols, or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, or upconvert) the output sample stream to obtain a downlink signal.

The modems 232a through 232t may transmit a set of downlink signals (for example, T downlink signals) via the corresponding set of antennas 234. A downlink signal may include a DCI communication, a medium access control (MAC) control element (MAC-CE) communication, a radio resource control (RRC) communication, or another type of downlink communication. A downlink signal may carry one or more transport blocks of data. A transport block may refer to a unit of data that is transmitted over an air interface in the wireless network 100. A data stream may be encoded into a plurality of transport blocks for transmission over the air interface. The quantity of transport blocks for a particular data stream may be associated with a transport block size. The transport block size may be based on or otherwise associated with radio channel conditions on the air interface, the MCS used for encoding the data, the downlink resources allocated for transmitting the data, and/or another parameter. In general, the larger the transport block size, the greater the amount of data that can be transmitted in a single transmission, which reduces signaling overhead. However, larger transport block sizes may be more prone to transmission and/or reception errors, which may be mitigated by more robust error correction techniques.

One or more antennas of the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2.

Each of the antenna elements of an antenna 234 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal. Antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between the UE 120 and the network node 110, such as for millimeter wave communications. In such a case, the network node 110 may provide the UE 120 with a configuration of transmission configuration indicator (TCI) states that respectively indicate beams that may be used by the UE 120, such as for receiving a PDSCH. The network node 110 may indicate an activated TCI state to the UE 120, which the UE 120 may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCelllndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink/uplink beam indication in a unified TCI framework. In some cases, the network may support layer 1 (L1)-based beam indication using at least UE-specific (unicast) DCI to indicate joint or separate DL/UL beam indications from active TCI states. In some cases, existing DCI formats 1_1 and/or 1_2 may be reused for beam indication. The network node 110 may include a support mechanism for the UE 120 to acknowledge successful decoding of a beam indication. For example, the acknowledgment/negative acknowledgment of the PDSCH scheduled by the DCI carrying the beam indication may be also used as an acknowledgement (ACK) for the DCI.

Beam indications may be provided for carrier aggregation scenarios. In a unified TCI framework, information the network may support common TCI state ID update and activation to provide common QCL and/or common UL transmission spatial filter or filters across a set of configured component carriers. This type of beam indication may apply to intra-band carrier aggregation (CA), as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

For communication on an uplink, uplink signals from a UE 120 or other UEs may be received on an uplink by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and control information sent by the UE 120. The receive processor 238 may provide the decoded data to a data sink 239 and provide the decoded control information to the controller/processor 240. The term “controller/processor” may refer to one or more controllers and/or one or more processors.

The network node 110 may use the communication unit 244 to communicate with a network controller 130. The communication unit 244 may support wired and/or wireless communication protocols and/or connections such as Ethernet, optical fiber, and/or common public radio interface (CPRI), among other examples. The network node 110 may use the communication unit 244 to communicate with a network controller 130 to transmit and/or receive data associated with the UE 120 or to perform network control signaling, among other examples.

The network node 110 may use the scheduler 246 to schedule one or more UEs 120 for downlink or uplink communications. In some aspects, the scheduler 246 may use DCI to dynamically schedule transmissions to the UE 120 and/or transmissions from the UE 120. In some aspects, the scheduler 246 may use an RRC configuration (e.g., a semi-static configuration) to perform semi-persistent scheduling (SPS) or configured grant (CG) configuration for a UE 120, where the scheduler 246 may allocate a recurring time domain resources and/or frequency domain resources that the UE 120 may use to transmit and/or receive communications in the wireless network 100.

One or more of the transmit processor 220, the TX MIMO processor 230, the modem 232, the antenna 234, the MIMO detector 236, the receive processor 238, and/or the controller/processor 240 may be included in a radio frequency (RF) chain of the network node 110. An RF chain may include filters, mixers, oscillators, amplifiers, analog-to-digital converters (ADCs), and/or other devices that convert between an analog signal (such as for transmission or reception on an air interface) and a digital signal (such as for processing by one or more processors of the network node 110).

The UE 120 may include a set of antennas 252 (shown as antennas 252a through 252r, where r≥1), a set of modems 254 (shown as modems 254a through 254r, where r≥1), a MIMO detector, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be used by a processor (for example, the controller/processor 280) and the memory 282 to perform aspects of any of the methods described herein. In some aspects, the UE 120 may include another interface, another communication component, and/or another component that facilitates communication with the network node 110 and/or another UE 120.

One or more antennas of the set of antennas 252 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. In some examples, each of the antenna elements of an antenna 234 may include one or more sub-elements for radiating or receiving radio frequency signals.

For communication on the downlink, the set of antennas 252 may receive the downlink signals from the network node 110 or other network nodes 110 and may provide a set of received signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to a data sink 260, and may provide decoded control information and system information to a controller/processor 280.

For communication on the uplink, the transmit processor 264 may receive and process data from a data source 262 and control information from the controller/processor 280. The data may include data that is to be transmitted to the network node 110 and/or to another UE. The control information may include one or more parameters, feedback, one or more signal measurements, and/or other types of control information. In some aspects, the receive processor 258 and/or the controller/processor 280 may determine one or more parameters for a received signal (such as received from the network node 110 or another UE), such as a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266 if applicable, further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, or upconvert) the output sample stream to obtain an uplink signal.

The modems 254a through 254r may transmit a set of uplink signals (for example, R downlink signals) via the corresponding set of antennas 252. An uplink signal may include a uplink control information (UCI) communication, a MAC-CE communication, an RRC communication, or another type of uplink communication. An uplink signal may carry one or more transport blocks of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

The network controller 130 may include a communication unit 294, a controller/processor 290, and a memory 292. The network controller 130 may include, for example, one or more devices in a core network. The network controller 130 may communicate with the network node 110 on a backhaul link via the communication unit 294. The network controller 130 may provide the UE 120 with access to (via the network node 110 and the core network) a local area network (LAN), a wide area network (WAN) such as the Internet, a storage area network, a local data network, a private network, a content delivery network (CDN), and/or another network that is communicatively connected with the core network. In some aspects, the network controller 130 may facilitate access by the UE 120 to one or more services hosted in the core network, such as content delivery services, gaming services, storage services, streaming services, and/or another type of services.

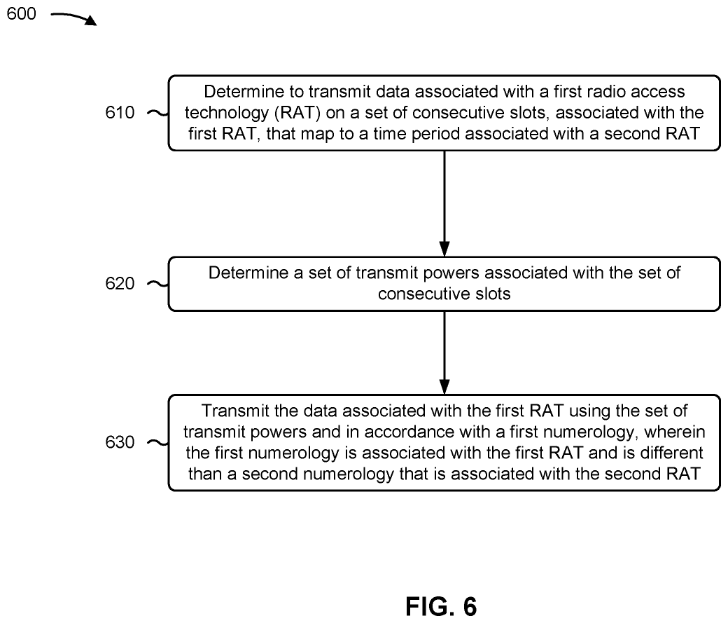

The controller/processor 240 of the network node 110, the controller/processor 280 of the UE 120, or any other component(s) of FIG. 2 may implement one or more techniques or perform one or more operations associated with sidelink transmission power control for NR sidelink and LTE sidelink co-channel coexistence, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, or other processes as described herein. The memory 242 and the memory 282 may store data and program codes for the network node 110 and the UE 120, respectively. In some examples, the memory 242 or the memory 282 may include a non-transitory computer-readable medium storing a set of instructions (for example, code or program code) for wireless communication. For example, the set of instructions, when executed (for example, directly, or after compiling, converting, or interpreting) by one or more processors of the network node 110 or the UE 120, may cause the one or more processors to perform process 600 of FIG. 6, or other processes as described herein. In some examples, executing instructions may include running the instructions, converting the instructions, compiling the instructions, or interpreting the instructions, among other examples.

In some aspects, a UE (e.g., the UE 120) includes means for determining to transmit data associated with a first RAT on a set of consecutive slots, associated with the first RAT, that map to a time period associated with a second RAT; means for determining a set of transmit powers corresponding to the set of consecutive slots; and/or means for transmitting the data associated with the first RAT using the set of transmit powers and in accordance with a first numerology, wherein the first numerology is associated with the first RAT and is different than a second numerology that is associated with the second RAT. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “memory” or “a memory” should be understood to refer to “one or more memories.” Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

As indicated above, FIG. 2 is provided as an example. Other examples may differ from what is described with regard to FIG. 2.

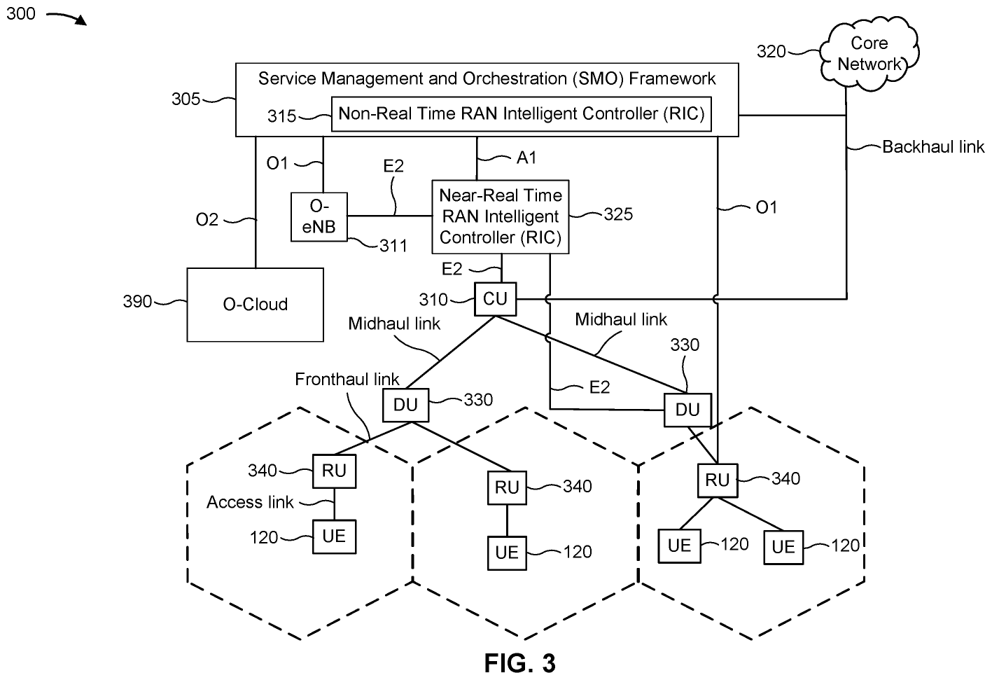

FIG. 3 is a diagram illustrating an example disaggregated base station architecture 300 in accordance with the present disclosure. One or more components of the example disaggregated base station architecture 300 may be, include, or be included in a network node (for example, the network node 110). The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). The CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces for receiving or transmitting signals, data, or information (collectively, signals) via a wired or wireless transmission medium. Each of the units, or an associated processor or controller providing instructions to one or multiple communication interfaces of the respective unit, may communicate with one or more of the other units via the transmission medium on a wired interface and/or a wireless interface.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface for communicating signals with other control functions hosted by the CU 310. The CU 310 may handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface for communicating signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may support RAN deployment and provisioning of non-virtualized and virtualized network elements. For non-virtualized network elements, the SMO Framework 305 may support the deployment of dedicated physical resources for RAN coverage requirements, which may be managed via an operations and maintenance interface (such as an O1 interface). For virtualized network elements, the SMO Framework 305 may interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 that supports functionality of the SMO Framework 305.

The Non-RT RIC 315 may include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

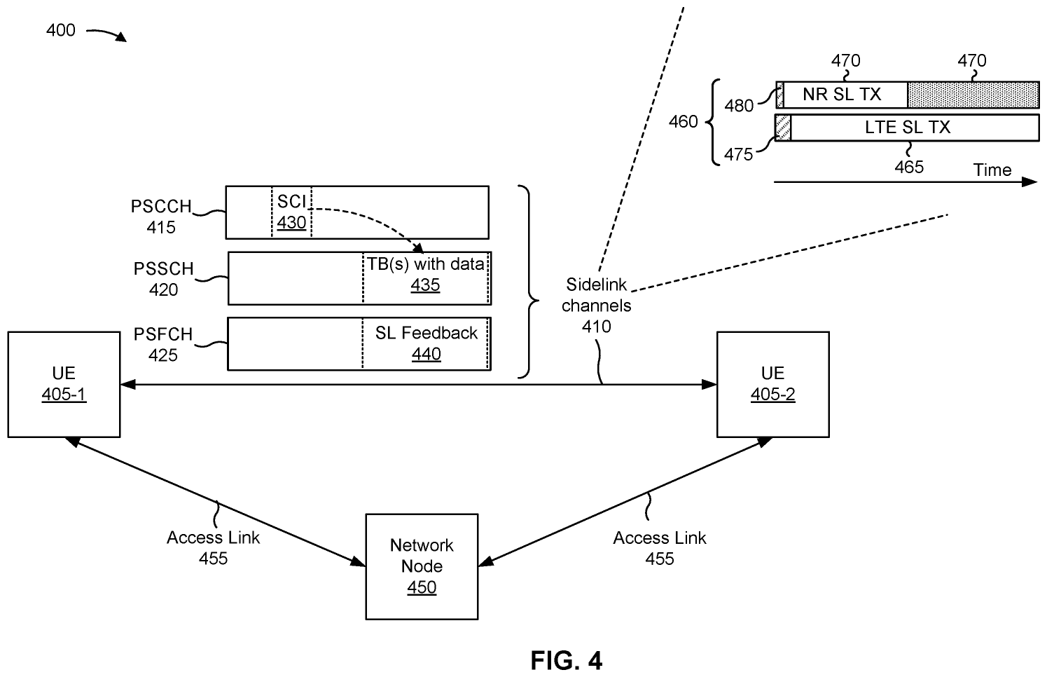

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a PSCCH 415, a PSSCH 420, and/or a PSFCH 425. The PSCCH 415 may be used to communicate control information, similar to a PDCCH and/or a PUCCH used for cellular communications with a network node 110 via an access link or an access channel. The PSSCH 420 may be used to communicate data, similar to a PDSCH and/or a PUSCH used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement/negative acknowledgement (ACK/NACK) information), TPC, and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an ACK in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “sidelink HARQ feedback information”).

A HARQ-ACK bit may be referred to as an ACK/NACK and/or a HARQ-ACK and may be associated with a HARQ process. “HARQ process” refers to the determination of whether to report an ACK or NACK associated with a transmission, a time resource associated with the transmission (e.g., a symbol or a slot), and/or a frequency resource associated with the transmission (e.g., a resource block (RB), a subchannel, a channel, a bandwidth, and/or a bandwidth part). Accordingly, an ACK/NACK may be interchangeably referred to as being associated with a transmission, a time resource, a frequency resource, and/or a HARQ process.

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a CSI report trigger.

In some aspects, the one or more sidelink channels 410 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 430) may be transmitted in sub-channels using specific RBs across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405-1 may operate using a sidelink transmission mode (e.g., Mode 1) where resource selection and/or scheduling is performed by a network node 110 (e.g., a base station, a CU, or a DU). For example, the UE 405-1 may receive a grant (e.g., in DCI or in an RRC message, such as for configured grants) from the network node 110 (e.g., directly or via one or more network nodes) for sidelink channel access and/or scheduling. In some aspects, a UE 405-1 may operate using a transmission mode (e.g., Mode 2) where resource selection and/or scheduling is performed by the UE 405-1 (e.g., rather than a network node 110). In some aspects, the UE 405-1 may perform resource selection and/or scheduling by sensing channel availability for transmissions. For example, the UE 405-1 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405-1 may perform resource selection and/or scheduling using SCI 430 received in the PSCCH 415, which may indicate occupied resources and/or channel parameters. Additionally, or alternatively, the UE 405-1 may perform resource selection and/or scheduling by determining a channel busy ratio (CBR) associated with various sidelink channels, which may be used for rate control (e.g., by indicating a maximum number of resource blocks that the UE 405-1 can use for a particular set of subframes).

In the transmission mode where resource selection and/or scheduling is performed by a UE 405-1, the UE 405-1 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405-1 may generate a sidelink grant that indicates one or more parameters for SPS, such as a periodicity of a sidelink transmission. Additionally, or alternatively, the UE 405-1 may generate a sidelink grant for event-driven scheduling, such as for an on-demand sidelink message.

As shown, a network node 450 may communicate with the UE 405-1 and/or the UE 405-2 (e.g., directly or via one or more network nodes), such as via an access link 455. A direct link between the UEs 405-1 and 405-2 (e.g., via a PC5 interface) may be referred to as a sidelink, and a direct link between a network node 450 and a UE 405-1 or 405-2 (e.g., via a Uu interface) may be referred to as an access link. Sidelink communications may be transmitted via the sidelink, and access link communications may be transmitted via the access link. An access link communication may be either a downlink communication (from the network node 450 to the UE 405-1 or 405-2) or an uplink communication (from a UE 405-1 or 405-2 to the network node 450).

Additionally, or alternatively, the UE 405-1 and/or 405-2 can perform resource selection and/or scheduling using SCI 430 received in the PSCCH 415, which can indicate occupied resources and/or channel parameters. Additionally, or alternatively, the UE 405-1 and/or 405-2 can perform resource selection and/or scheduling by determining a CBR associated with various sidelink channels, which can be used for rate control (e.g., by indicating a maximum number of resource blocks that the UE 405-1 and/or 405-2 can use for a particular set of subframes).

In the second transmission mode, the UE 405-1 and/or 405-2 can generate sidelink grants, and can transmit the grants in SCI 430. A sidelink grant can indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), and/or one or more subframes to be used for the upcoming sidelink transmission. In some aspects, a UE 405-1 and/or 405-2 can generate a sidelink grant that indicates one or more parameters for SPS, such as a periodicity of a sidelink transmission. Additionally, or alternatively, the UE 405-1 and/or 405-2 can generate a sidelink grant for event-driven scheduling, such as for an on-demand sidelink message.

In some cases, multiple sidelink networks can share a sidelink channel. For example, a first RAT (e.g., NR) and a second RAT (e.g., LTE) can coexist on a sidelink shared channel (which may be referred to as a “co-channel”) in a scenario referred to as co-channel coexistence. For example, as shown, a co-channel 460 may include a slot (e.g., an LTE subframe) 465 corresponding to LTE and a set of consecutive slots 470 corresponding to NR. Transmissions on the NR sidelink (SL) could cause interference (in-band emissions) to the LTE SL reception, as well as affect the received power at a receiver UE. Additionally, the LTE SL includes an OFDM symbol 475 at the beginning of the subframe 465 that is used by the receiver to train its AGC. NR SL slots 470 have a similar structure where the first OFDM symbol 480 is also used for AGC training. In some cases, an LTE receiver UE can set its gain in the first symbol of the LTE subframe 465 and an NR receiver UE can set its gain at the beginning of the first slot 470 of the set of consecutive slots 470. If the received power changes during the reception of the LTE subframe 465 (e.g., due to an NR transmission being shorter than the LTE subframe), the gain could be incorrect at the receiver and performance can be degraded as a result.

Some aspects of the techniques described herein include setting, at a UE associated with a first RAT, transmit power levels for a set of consecutive slots that map to a time period associated with a second RAT. For example, transmitting on a number of slots that would fully overlap with the time period associated with the second RAT can facilitate avoiding issues with incorrect gain control. For example, to enable LTE SL UEs to make a correct AGC setting at the AGC symbols, an NR SL transmitter transmitting PSSCH over the set of consecutive slots (which may include two slots and be referred to as “paired slot”) may transmit at similar or equal power levels over the paired slot. In this way, some aspects may facilitate transmitting over a sidelink associated with a first RAT on a co-channel with a second RAT, while facilitating correct AGC setting by the UE communicating on the second RAT across the overlapping time period, thereby improving sidelink network performance.

As indicated above, FIG. 4 is provided as an example. Other examples may differ from what is described with regard to FIG. 4.

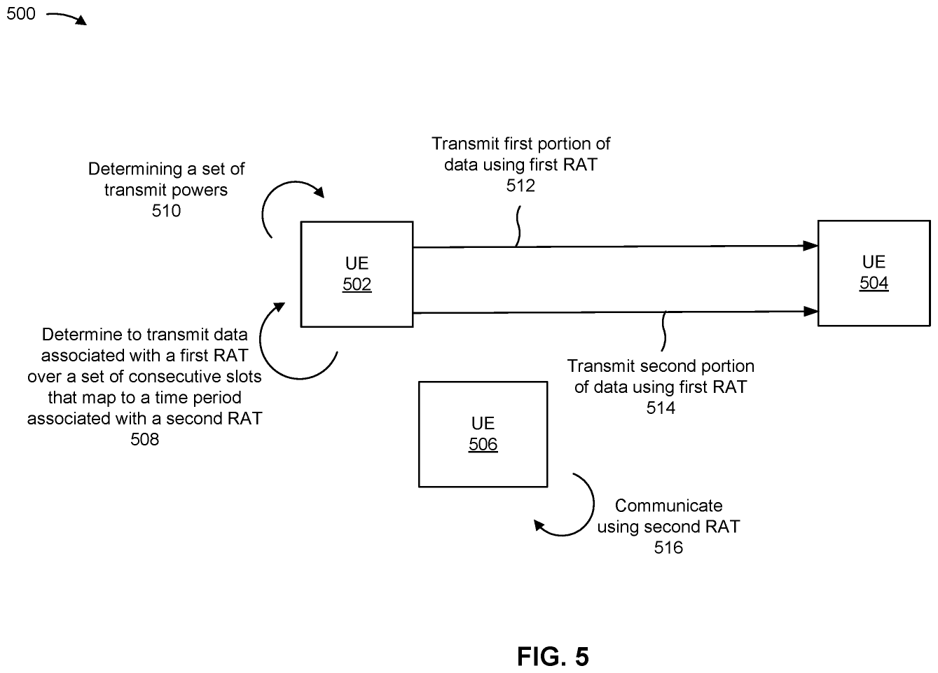

FIG. 5 is a diagram illustrating an example 500 associated with sidelink transmission power control for NR and LTE co-channel coexistence, in accordance with the present disclosure. As shown, a UE 502 may communicate with a second UE 504. For example, the UEs 502 and 504 may communicate over a sidelink associated with a first RAT (e.g., NR). A UE 506 may communicate with one or more other UEs over a sidelink associated with a second RAT (e.g., LTE). In some aspects, the UEs 502, 504, and 506 may be, be similar to, include, or be included in the UE 120 depicted in FIGS. 1-4.

As shown by reference number 508, the UE 502 may determine to transmit data associated with a first RAT on a set of consecutive slots, associated with the first RAT. The set of consecutive slots may map to a time period (e.g., a subframe or a slot) associated with a second RAT. In some aspects, the first RAT may correspond to an NR standard and the second RAT may correspond to an LTE standard. In some aspects, the UE 502 may determine to transmit the data associated with the first RAT on the set of consecutive slots based on a first priority associated with a first portion of the data, to be transmitted on a first slot of the set of consecutive slots, being equal to a second priority associated with a second portion of the data to be transmitted on a second slot of the set of consecutive slots. In some aspects, the UE 502 may determine to transmit the data associated with the first RAT on the set of consecutive slots based on a time associated with a resource selection operation. In some aspects, the UE 502 may determine to transmit the data associated with the first RAT on the set of consecutive slots based on a change in a corresponding MCS satisfying an MCS change threshold. In some aspects, the UE based on a change in an RB allocation satisfying an RB allocation change threshold. In some aspects, the UE 502 may determine that a change, associated with transmitting the data on the set of consecutive slots, in at least one of an MCS or an RB allocation fails to change a future resource reservation indicated by the UE 502.

As shown by reference number 510, the UE 502 may determine a set of transmit powers associated with the set of consecutive slots. For example, the set of consecutive slots may include a paired slots having two consecutive slots, and the UE 502 may determine a first transmit power, P(i), associated with the first slot and a second transmit power, P(i+1), associated with the second slot. In some aspects, the first transmit power is equal to the second transmit power. For example, in some aspects, P(i)=P(i+1) when the UE 502 transmits over consecutive slots. In some other aspects, a difference between the first transmit power P(i) and the second transmit power P(i+1) may satisfy a power difference condition. The power difference condition may include a threshold value or a range of values. For example, in some aspects, Δ₁<P(i)−P(i+1)<Δ₂ dB, where Δ₁, Δ₂ are specified in a wireless communication standard and/or configured by a network node. In some aspects, the first transmit power is greater than or equal to the second transmit power.

In some aspects, and as described herein, the first slot may overlap a first portion of the time period associated with the second RAT and the second slot may overlap a second portion of the time period. The UE 502 may determine a first initial transmit power associated with the first slot, determine a second initial transmit power associated with the second slot, and update at least one of the first initial transmit power with the first transmit power or the second initial transmit power with the second transmit power based on determining the first initial transmit power and the second initial transmit power.

For example, in implementations in which the first RAT is NR, for a PSSCH transmission, an initial transmit power may be chosen based on the formula:

P_{PSSCH}(i)=min(P_{CMAX},P_{MAX,CBR},min(P_{PSSCH,D}(i),P_{PSSCH,SL}(i)) [dBm]

where P_{MAX,CBR} is determined based on the CBR range associated with a traffic priority value; P_{PSSCH,D}(i) and P_{PSSCH,SL}(i) depend on the number of RBs allocated, the pathloss estimate/reference signal power measurements and other emission requirements for coexistence with access link transmissions in the uplink or downlink; and P_{CMAX} is a UE specific constant which is dependent on the MCS order and out-of-band emission limits. In some aspects, the first transmit power may be equal to the second transmit power such that a common transmit power, P_{coex}, is used for both slots. In some aspects, the common transmit power (e.g., the first transmit power) may be equal to a minimum of the first initial transmit power and the second initial transmit power. For example, given the determination of P(i) and P(i+1), the UE 502 may determine to use a common transmit power P_{coex} over both the slots where P_{coex}(i)=P_{coex}(i+1)=min(P(i), P(i+1)). In some aspects, common transmit power may be equal to the maximum of the first initial transmit power and the second initial transmit power, where P_{coex}(i)=P_{coex}(i+1)=max(P(i), P(i+1)).

In some aspects, the UE 502 may update the at least one of the first initial transmit power or the second initial transmit power by adjusting at least one of the initial transmit power or the second initial transmit power in accordance with a power scaling value. For example, the UE 502 may increase or decrease the transmit power of the PSSCH transmission over the second overlapping slot. For example, the UE 502 may increase or decrease at least one of the first initial transmit power or the second initial transmit power to ensure that P(i)−Θ≤P(i+1)≤P(i)+0 dBm, where Θ is a power scaling value indicated by a wireless communication standard or configured by the network.

In some aspects, the UE 502 may update the at least one of the first initial transmit power or the second initial transmit power based on a spectral emission requirement and/or an access link coexistence requirement. For example, in some aspects, the updates to the transmit powers may be constrained by the emission requirements on both slots meeting spectral emission requirements. For example, if P_{coex}(i)=P_{coex}(i+1)=max(P(i), P(i+1)), then the UE 502 may update at least one of the first or second initial transmit powers to ensure that P_{coex} (i)≤min(P_{CMA}X(i)>P_{CMA}X(i+1)), where the parameter P_{CMA}X is set to control spectral emissions. In some examples, the updates to the transmit powers may be constrained by the selected transmit powers meeting requirements for coexistence with access link (Uu) transmissions. For example, P_{coex}( )=P_{coex}(i+1)≤min (P_{PSSCH,D} (P_{PSSCH,D}(i+1)), where P_{PSSCH,D} controls interference with the access link transmissions. In some aspects, the UE 502 may determine the first transmit power P(i) associated with the transmission overlapping with the first half of the time period associated with the second RAT. For the second consecutive PSSCH transmission, the UE 502 may determine the MCS and the number of RB allocations on the second consecutive PSSCH transmission such that P(i)−Θ≤P(i+1)≤P(i)+Θ [dBm].

In some aspects, the determination to transmit on consecutive slots may be made at least a Tₐ time before the actual transmission, where Tₐ is determined based on the time associated with resource selection. In some aspects, the determination to transmit on consecutive slots may be made only if the changes in MCS and RB allocation are within a specified or configured threshold. In some aspects, the determination to transmit on consecutive slots may be made only if the changes in MCS and RB allocation do not change a future resource reservation already indicated by the UE 502 (e.g., where an SCI has already indicated resource reservation for retransmissions or periodic transmissions). In some aspects, the first transmit power may be based on a first priority associated with the first portion of the data and the second transmit power may be based on a second priority associated with the second portion of the data.

A numerology refers to a set of parameters that defines one or more waveform properties in a wireless communication network. These parameters may include, for example, sub-carrier spacing (SCS), symbol duration, and/or cyclic prefix length, among other examples. Different numerologies may be defined to optimize the wireless communication network for certain requirements, such as coverage, capacity, or latency. As described herein, the UE 120 and the network node 110 may communicate using a first RAT or a second RAT. For example, the UE 120 and the network node 110 may communicate using LTE or NR. In LTE, the numerology may be relatively fixed. For example, the SCS may be 15 kHz or 30 kHz, and the cyclic prefix may be either normal or extended. In NR, the numerology may be more flexible. For example, the SCS may be 15 kHz, 30 kHz, 60 kHz, 120 kHz, or 240 kHz, among other examples, and the cyclic prefix may have different lengths to accommodate various propagation conditions and delay spreads.

After determining the set of transmit powers, the UE 502 may transmit the data associated with the first RAT in association with a first numerology, associated with the first RAT, that is different from a second numerology associated with the second RAT. For example, as shown by reference number 512, the UE 502 may transmit a first portion of the data on a first slot of the set of consecutive slots. As shown by reference number 514, the UE 502 may transmit a second portion of the data on a second slot of the set of consecutive slots. As shown by reference number 516, the UE 506 may concurrently communicate using the second RAT (e.g., on the co-channel being used by the UE 502). In some aspects, the UE 502 may transmit the first portion of the data using the first transmit power and the second portion of the data using the second transmit power.

In some aspects, the UE 502 may transmit the first portion of the data in the first slot of the set of consecutive slots based on a first priority associated with the first portion of the data and a second priority associated with a second portion of the data. For example, in some aspects, the transmit powers over the two consecutive slots P(i) and P(i+1) may be dependent on the priority of the two PSSCH transmissions. In some aspects, the UE 502 may determine to transmit the packet with the higher priority or higher power in the first of the two consecutive slots. The transmit power on the consecutive slot P(i+1) may then be determined based on the transmit power of the first slot P(i) associated with the high priority/high power transmission. The MCS and the RB allocation of the second transmission may be changed such that the transmit powers of the consecutive transmissions match, or are within a specified (or configured) range of each other. In some aspects, the UE 502 may only transmit on consecutive slots overlapping with a time period associated with a second RAT if the priorities associated with the PSSCH transmissions are the same.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 502) performs operations associated with sidelink transmission power control for NR sidelink and LTE sidelink co-channel coexistence.

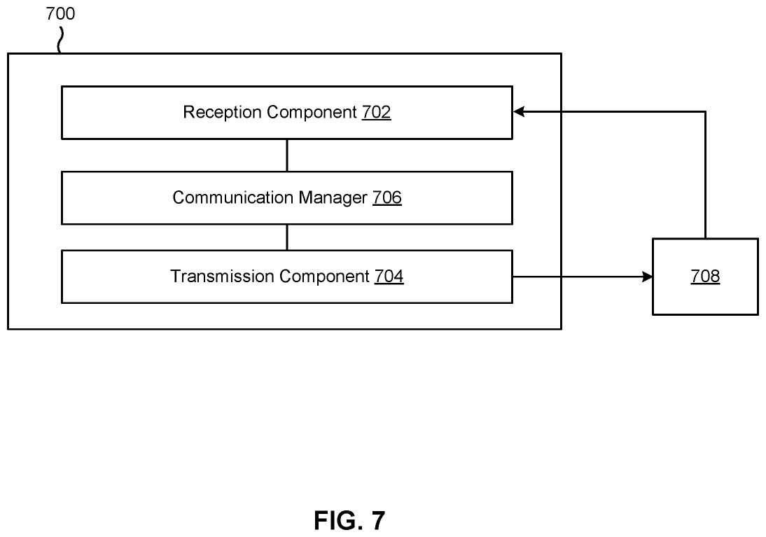

As shown in FIG. 6, in some aspects, process 600 may include determining to transmit data associated with a first RAT on a set of consecutive slots, associated with the first RAT, that map to a time period associated with a second RAT (block 610). For example, the UE (e.g., using communication manager 706, depicted in FIG. 7) may determine to transmit data associated with a first RAT on a set of consecutive slots, associated with the first RAT, that map to a time period associated with a second RAT, as described above.

As further shown in FIG. 6, in some aspects, process 600 may include determining a set of transmit powers associated with the set of consecutive slots (block 620). For example, the UE (e.g., using transmission component 704 and/or communication manager 706, depicted in FIG. 7) may determine a set of transmit powers associated with the set of consecutive slots, as described above.

As further shown in FIG. 6, in some aspects, process 600 may include transmitting the data associated with the first RAT using the set of transmit powers and in accordance with a first numerology, wherein the first numerology is associated with the first RAT and is different than a second numerology that is associated with the second RAT (block 630). For example, the UE (e.g., using transmission component 704 and/or communication manager 706, depicted in FIG. 7) may transmit the data associated with the first RAT using the set of transmit powers and in accordance with a first numerology, wherein the first numerology is associated with the first RAT and is different than a second numerology that is associated with the second RAT, as described above.

Process 600 may include additional aspects, such as any single aspect or any combination of aspects described below and/or in connection with one or more other processes described elsewhere herein.

In a first aspect, the first RAT corresponds to an NR standard and the second RAT corresponds to an LTE standard. In a second aspect, transmitting the data comprises transmitting, using a first transmit power of the set of transmit powers, a first portion of the data on a first slot of the set of consecutive slots, and transmitting, using a second transmit power of the set of transmit powers, a second portion of the data on a second slot of the set of consecutive slots. In a third aspect, alone or in combination with the second aspect, the first transmit power is equal to the second transmit power.

In a fourth aspect, alone or in combination with one or more of the second through third aspects, a difference between the first transmit power and the second transmit power satisfies a power difference condition. In a fifth aspect, alone or in combination with the fourth aspect, the power difference condition comprises a threshold value. In a sixth aspect, alone or in combination with one or more of the fourth through fifth aspects, the power difference condition comprises a range of values. In a seventh aspect, alone or in combination with the second aspect, the first transmit power is greater than or equal to the second transmit power. In an eighth aspect, alone or in combination with one or more of the second through seventh aspects, the first slot overlaps a first portion of the slot associated with the second RAT.

In a ninth aspect, alone or in combination with one or more of the second through eighth aspects, process 600 includes determining a first initial transmit power associated with the first slot, determining a second initial transmit power associated with the second slot, and updating at least one of the first initial transmit power with the first transmit power or the second initial transmit power with the second transmit power based on determining the first initial transmit power and the second initial transmit power. In a tenth aspect, alone or in combination with the ninth aspect, the first transmit power is equal to the second transmit power, and wherein the first transmit power is equal to a minimum of the first initial transmit power and the second initial transmit power. In an eleventh aspect, alone or in combination with the ninth aspect, the first transmit power is equal to the second transmit power, and wherein the first transmit power is equal to a maximum of the first initial transmit power and the second initial transmit power.

In a twelfth aspect, alone or in combination with one or more of the ninth through eleventh aspects, updating the at least one of the first initial transmit power or the second initial transmit power comprises adjusting at least one of the initial transmit power or the second initial transmit power in accordance with a power scaling value. In a thirteenth aspect, alone or in combination with one or more of the ninth through twelfth aspects, updating the at least one of the first initial transmit power or the second initial transmit power comprises updating the at least one of the initial transmit power or the second initial transmit power based on a spectral emission requirement. In a fourteenth aspect, alone or in combination with one or more of the ninth through thirteenth aspects, updating the at least one of the first initial transmit power or the second initial transmit power comprises updating the at least one of the initial transmit power or the second initial transmit power based on an access link coexistence requirement. In a fifteenth aspect, alone or in combination with one or more of the ninth through fourteenth aspects, updating the at least one of the first initial transmit power or the second initial transmit power comprises updating the second initial transmit power based on a modulation and coding scheme and a quantity of resource blocks associated with the second portion of the data.

In a sixteenth aspect, alone or in combination with one or more of the second through fifteenth aspects, the first transmit power is based on a first priority associated with the first portion of the data and the second transmit power is based on a second priority associated with the second portion of the data. In a seventeenth aspect, alone or in combination with one or more of the first through sixteenth aspects, transmitting a first portion of the data in a first slot of the set of consecutive slots comprises transmitting the first portion of the data in the first slot based on a first priority associated with the first portion of the data and a second priority associated with a second portion of the data. In an eighteenth aspect, alone or in combination with one or more of the first through seventeenth aspects, determining to transmit the data associated with the first RAT on the set of consecutive slots comprises determining to transmit the data on the set of consecutive slots based on a first priority associated with a first portion of the data, to be transmitted on a first slot of the set of consecutive slots, being equal to a second priority associated with a second portion of the data to be transmitted on a second slot of the set of consecutive slots. In a nineteenth aspect, alone or in combination with one or more of the first through eighteenth aspects, determining to transmit the data associated with the first RAT on the set of consecutive slots comprises determining, at a determination time, to transmit the data on the set of consecutive slots, wherein the determination time is based on a time associated with a resource selection operation.

In a twentieth aspect, alone or in combination with one or more of the first through nineteenth aspects, determining to transmit the data associated with the first RAT on the set of consecutive slots comprises determining to transmit the data on the set of consecutive slots based on a change in a corresponding MCS satisfying an MCS change threshold. In a twenty-first aspect, alone or in combination with one or more of the first through twentieth aspects, determining to transmit the data associated with the first RAT on the set of consecutive slots comprises determining to transmit the data on the set of consecutive slots based on a change in an RB allocation satisfying an RB allocation change threshold. In a twenty-second aspect, alone or in combination with one or more of the first through twenty-first aspects, process 600 includes determining that a change, associated with transmitting the data on the set of consecutive slots, in at least one of a modulation and coding scheme or a resource block allocation fails to change a future resource reservation indicated by the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may determine to transmit data associated with a first RAT on a set of consecutive slots, associated with the first RAT, that map to a time period associated with a second RAT. The transmission component 704 may transmit the data associated with the first RAT in association with a first numerology, associated with the first RAT, that is different from a second numerology associated with the second RAT. The communication manager 706 may determine a set of transmit powers corresponding to the set of consecutive slots.

The communication manager 706 may determine a first initial transmit power associated with the first slot. The communication manager 706 may determine a second initial transmit power associated with the second slot. The communication manager 706 may update at least one of the first initial transmit power with the first transmit power or the second initial transmit power with the second transmit power based on determining the first initial transmit power and the second initial transmit power. The communication manager 706 may determine that a change, associated with transmitting the data on the set of consecutive slots, in at least one of a modulation and coding scheme or a resource block allocation fails to change a future resource reservation indicated by the UE.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: determining to transmit data associated with a first RAT on a set of consecutive slots, associated with the first radio access technology (RAT), that map to a time period associated with a second RAT; determining a set of transmit powers associated with the set of consecutive slots; and transmitting the data associated with the first RAT using the set of transmit powers and in accordance with a first numerology, wherein the first numerology is associated with the first RAT and is different than a second numerology that is associated with the second RAT.

Aspect 2: The method of Aspect 1, wherein the first RAT corresponds to a New Radio standard and the second RAT corresponds to a Long-Term Evolution standard.

Aspect 3: The method of either of claim 1 or 2, wherein transmitting the data comprises: transmitting, using a first transmit power of the set of transmit powers, a first portion of the data on a first slot of the set of consecutive slots; and transmitting, using a second transmit power of the set of transmit powers, a second portion of the data on a second slot of the set of consecutive slots.

Aspect 4: The method of Aspect 3, wherein the first transmit power is equal to the second transmit power.

Aspect 5: The method of either of Aspects 3 or 4, wherein a difference between the first transmit power and the second transmit power satisfies a power difference condition.

Aspect 6: The method of Aspect 5, wherein the power difference condition comprises a threshold value.

Aspect 7: The method of either of Aspects 5 or 6, wherein the power difference condition comprises a range of values.

Aspect 8: The method of Aspect 3, wherein the first transmit power is greater than or equal to the second transmit power.

Aspect 9: The method of any of Aspects 3-8, wherein the first slot overlaps a first portion of the slot associated with the second RAT.

Aspect 10: The method of any of Aspects 3-9, further comprising: determining a first initial transmit power associated with the first slot; determining a second initial transmit power associated with the second slot; and updating at least one of the first initial transmit power with the first transmit power or the second initial transmit power with the second transmit power based on determining the first initial transmit power and the second initial transmit power.

Aspect 11: The method of Aspect 10, wherein the first transmit power is equal to the second transmit power, and wherein the first transmit power is equal to a minimum of the first initial transmit power and the second initial transmit power.

Aspect 12: The method of any of Aspects 10-11, wherein the first transmit power is equal to the second transmit power, and wherein the first transmit power is equal to a maximum of the first initial transmit power and the second initial transmit power.

Aspect 13: The method of any of Aspects 10-12, wherein updating the at least one of the first initial transmit power or the second initial transmit power comprises adjusting at least one of the initial transmit power or the second initial transmit power in accordance with a power scaling value.

Aspect 14: The method of any of Aspects 10-13, wherein updating the at least one of the first initial transmit power or the second initial transmit power comprises updating the at least one of the initial transmit power or the second initial transmit power based on a spectral emission requirement.

Aspect 15: The method of any of Aspects 10-14, wherein updating the at least one of the first initial transmit power or the second initial transmit power comprises updating the at least one of the initial transmit power or the second initial transmit power based on an access link coexistence requirement.

Aspect 16: The method of any of Aspects 10-15, wherein updating the at least one of the first initial transmit power or the second initial transmit power comprises updating the second initial transmit power based on a modulation and coding scheme and a quantity of resource blocks associated with the second portion of the data.

Aspect 17: The method of any of Aspects 3-16, wherein the first transmit power is based on a first priority associated with the first portion of the data and the second transmit power is based on a second priority associated with the second portion of the data.

Aspect 18: The method of any of Aspects 1-17, wherein transmitting a first portion of the data in a first slot of the set of consecutive slots comprises transmitting the first portion of the data in the first slot based on a first priority associated with the first portion of the data and a second priority associated with a second portion of the data.

Aspect 19: The method of any of Aspects 1-18, wherein determining to transmit the data associated with the first RAT on the set of consecutive slots comprises determining to transmit the data on the set of consecutive slots based on a first priority associated with a first portion of the data, to be transmitted on a first slot of the set of consecutive slots, being equal to a second priority associated with a second portion of the data to be transmitted on a second slot of the set of consecutive slots.

Aspect 20: The method of any of Aspects 1-19, wherein determining to transmit the data associated with the first RAT on the set of consecutive slots comprises determining, at a determination time, to transmit the data on the set of consecutive slots, wherein the determination time is based on a time associated with a resource selection operation.

Aspect 21: The method of any of Aspects 1-20, wherein determining to transmit the data associated with the first RAT on the set of consecutive slots comprises determining to transmit the data on the set of consecutive slots based on a change in a corresponding modulation and coding scheme (MCS) satisfying an MCS change threshold.

Aspect 22: The method of any of Aspects 1-21, wherein determining to transmit the data associated with the first RAT on the set of consecutive slots comprises determining to transmit the data on the set of consecutive slots based on a change in a resource block (RB) allocation satisfying an RB allocation change threshold.

Aspect 23: The method of any of Aspects 1-22, further comprising determining that a change, associated with transmitting the data on the set of consecutive slots, in at least one of a modulation and coding scheme or a resource block allocation fails to change a future resource reservation indicated by the UE.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising one or more memories and one or more processors coupled to the one or more memories, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
one or more memories; and
one or more processors coupled to the one or more memories and configured to cause the UE to:
determine to transmit data associated with a first radio access technology (RAT) on a set of consecutive slots, associated with the first RAT, that map to a time period associated with a second RAT;
determine a set of transmit powers associated with the set of consecutive slots; and
transmit the data associated with the first RAT using the set of transmit powers and in accordance with a first numerology, wherein the first numerology is associated with the first RAT and is different than a second numerology that is associated with the second RAT.

2. The UE of claim 1, wherein the first RAT corresponds to a New Radio standard and the second RAT corresponds to a Long-Term Evolution standard.

3. The UE of claim 1, wherein the one or more processors, to cause the UE to transmit the data, are configured to cause the UE to:
transmit, using a first transmit power, a first portion of the data on a first slot of the set of consecutive slots; and
transmit, using a second transmit power, a second portion of the data on a second slot of the set of consecutive slots.

4. The UE of claim 3, wherein the first transmit power is equal to the second transmit power.

5. The UE of claim 3, wherein a difference between the first transmit power and the second transmit power satisfies a power difference condition.

6. The UE of claim 5, wherein the power difference condition comprises a threshold value.

7. The UE of claim 5, wherein the power difference condition comprises a range of values.

8. The UE of claim 3, wherein the first transmit power is greater than or equal to the second transmit power.

9. The UE of claim 3, wherein the first slot overlaps a first portion of the time period associated with the second RAT.

10. The UE of claim 3, wherein the one or more processors are further configured to cause the UE to:
determine a first initial transmit power associated with the first slot;
determine a second initial transmit power associated with the second slot; and
update at least one of the first initial transmit power with the first transmit power or the second initial transmit power with the second transmit power based on determining the first initial transmit power and the second initial transmit power.

11. The UE of claim 10, wherein the first transmit power is equal to the second transmit power, and wherein the first transmit power is equal to a minimum of the first initial transmit power and the second initial transmit power.

12. The UE of claim 10, wherein the first transmit power is equal to the second transmit power, and wherein the first transmit power is equal to a maximum of the first initial transmit power and the second initial transmit power.

13. The UE of claim 10, wherein the one or more processors, to cause the UE to update the at least one of the first initial transmit power or the second initial transmit power, are configured to cause the UE to adjust at least one of the first initial transmit power or the second initial transmit power in accordance with a power scaling value.

14. The UE of claim 10, wherein the one or more processors, to cause the UE to update the at least one of the first initial transmit power or the second initial transmit power, are configured to cause the UE to update the at least one of the first initial transmit power or the second initial transmit power based on a spectral emission requirement.

15. The UE of claim 10, wherein the one or more processors, to cause the UE to update the at least one of the first initial transmit power or the second initial transmit power, are configured to cause the UE to update the at least one of the first initial transmit power or the second initial transmit power based on an access link coexistence requirement.

16. The UE of claim 10, wherein the one or more processors, to cause the UE to update the at least one of the first initial transmit power or the second initial transmit power, are configured to cause the UE to update the second initial transmit power based on a modulation and coding scheme and a quantity of resource blocks associated with the second portion of the data.

17. The UE of claim 3, wherein the first transmit power is based on a first priority associated with the first portion of the data and the second transmit power is based on a second priority associated with the second portion of the data.

18. The UE of claim 1, wherein the one or more processors, to cause the UE to transmit a first portion of the data in a first slot of the set of consecutive slots, are configured to cause the UE to transmit the first portion of the data in the first slot based on a first priority associated with the first portion of the data and a second priority associated with a second portion of the data.

19. A method of wireless communication performed by a user equipment (UE), comprising:
determining to transmit data associated with a first radio access technology (RAT) on a set of consecutive slots, associated with the first RAT, that map to a time period associated with a second RAT;
determining a set of transmit powers associated with the set of consecutive slots; and
transmitting the data associated with the first RAT using the set of transmit powers and in accordance with a first numerology, wherein the first numerology is associated with the first RAT and is different than a second numerology that is associated with the second RAT.

20. A non-transitory computer-readable medium storing a set of instructions for wireless communication, the set of instructions comprising:
one or more instructions that, when executed by one or more processors of a user equipment (UE), cause the UE to:
determine to transmit data associated with a first radio access technology (RAT) on a set of consecutive slots, associated with the first RAT, that map to a time period associated with a second RAT;
determine a set of transmit powers associated with the set of consecutive slots; and
transmit the data associated with the first RAT using the set of transmit powers and in accordance with a first numerology, wherein the first numerology is associated with the first RAT and is different than a second numerology that is associated with the second RAT.
